(19) United States
(12) Patent Application Publication
(10) Pub. No.: US 2015/0331604 A1
(43) Pub. Date: Nov. 19, 2015

(54) PRESENTING STORED FILES IN WHITEBOARD APPLICATION

(71) Applicant: Microsoft Corporation, Redmond, WA (US)

(72) Inventors: David Tse, Kirkland, WA (US); Nathaniel Stott, Redmond, WA (US); Jason Lowell Reisman, Seattle, WA (US); Brian T. Albrecht, Kirkland, WA (US); Matthew C. Pohle, Bellevue, WA (US); Isaiah Ng, Kirkland, WA (US)

(21) Appl. No.: 14/493,085

(22) Filed: Sep. 22, 2014

Related U.S. Application Data
(60) Provisional application No. 61/996,781, filed on May 14, 2014.

(51) Int. Cl. G06F 3/0488; G06F 3/041; G06F 3/0485

(52) U.S. Cl. CPC G06F 3/04883; G06F 3/0485; G06F 3/041

(57) ABSTRACT

Systems and methods of presenting stored files in a whiteboard application executed on an interactive display are disclosed herein. One method may include executing the whiteboard application, and storing whiteboard input for an interaction session as a whiteboard file in memory of the interactive display device. The method may include receiving a request to browse stored whiteboard files, generating respective previews of the stored whiteboard files, and displaying the previews in an arrangement in a graphical user interface of the interactive display. The method may include receiving a selection input selecting a file of the stored whiteboard files via the interactive display, retrieving the selected file from the memory, and displaying the selected file on the interactive display. Finally, the method may include detecting that a second file has not been retrieved within a preset amount of time and deleting the second file from the memory.

### CROSS REFERENCE TO RELATED APPLICATIONS

This application claims priority to U.S. Application No. 61/996,781, filed May 14, 2014, and titled “Claiming Data from a Virtual Whiteboard”, the entire disclosure of which is incorporated by reference for all purposes.

### SUMMARY

Systems and methods of presenting stored files in a whiteboard application executed on an interactive display are disclosed herein. One method may include executing the whiteboard application, and for each of a plurality of interaction sessions, receiving whiteboard input and storing whiteboard input for an interaction session as a whiteboard file in memory of the interactive display device. The method may include receiving a request to browse the stored whiteboard files, generating respective previews of the stored whiteboard files, wherein each preview is a graphical representation of content of a respective stored whiteboard file, and displaying the previews in an arrangement in a graphical user interface (GUI) of the interactive display. The method may include receiving a selection input selecting a file of the stored whiteboard files via the interactive display, retrieving the selected file from the memory, and displaying the selected file on the interactive display. Finally, the method may include detecting that a second file of the stored whiteboard files has not been retrieved within a preset amount of time and deleting the second file from the memory.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a simplified schematic view of an interactive computing system including an interactive display.

FIG. 2 shows an illustrated view of the interactive display executing a whiteboard application.

FIG. 3A shows a graphical user interface (GUI) displayed on the interactive display in one arrangement.

FIG. 3B shows a shifted-over view of the GUI.

FIG. 4 shows the GUI snapped.

FIG. 5 shows the GUI in another arrangement.

FIGS. 6A and 6B show the GUI in yet another arrangement.

FIGS. 7A and 7B show a confidential mode of the whiteboard application.

FIGS. 8A-C show a flowchart of a method of presenting stored files in the whiteboard application executed on the interactive display.

FIG. 9 shows a simplified schematic view of a computing system.

### DETAILED DESCRIPTION

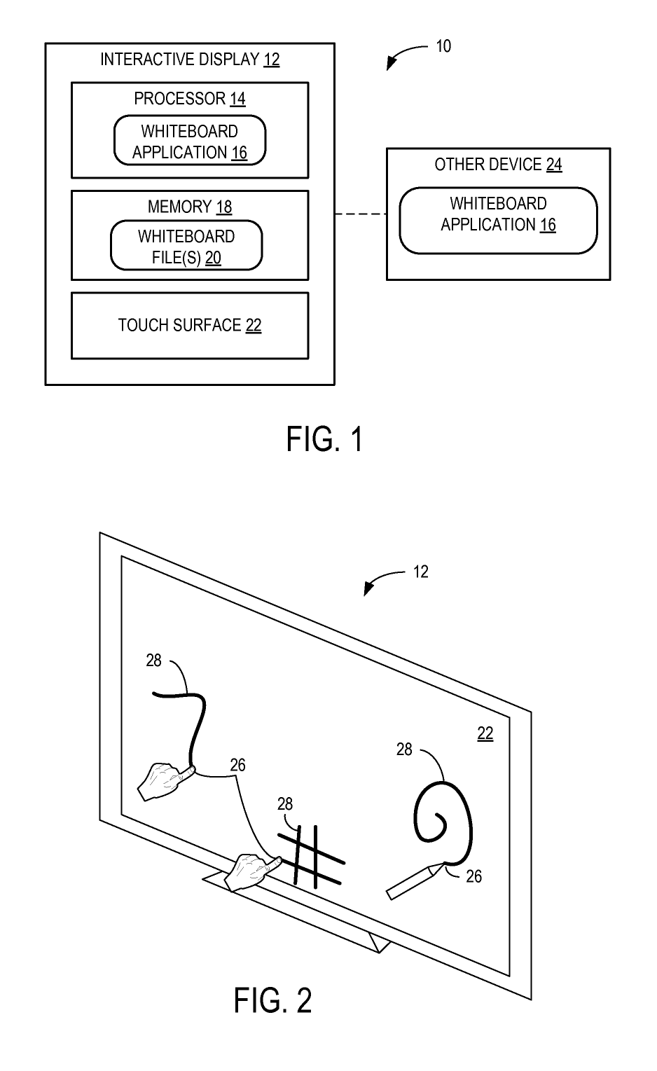

Accordingly, FIG. 1 shows a simplified schematic view of an interactive computing system 10 including an interactive display 12. The interactive display 12 may include a processor 14 configured to execute a whiteboard application 16. The interactive display 12 may further comprise memory 18 for storing at least one whiteboard file 20, and a touch surface 22. Additionally, the interactive display 12 may be communicatively connected to another device 24, such as a smartphone, tablet, or personal computer, and the other device 24 may also execute the whiteboard application 16. The interactive display 12 and the other device 24 may be connected after a security check is completed, for example, verifying a password or facial recognition.

FIG. 2 shows an illustrated view of the interactive display 12 executing the whiteboard application 16. The touch surface 22 may be a capacitive touch screen configured to receive touch input 26 from an input source such as a finger, stylus, etc. The touch input 26 may be received as whiteboard input 28 during an interaction session and stored as the whiteboard file 20 of FIG. 1. Other types of whiteboard input 28 may include typed text or transferred images, for example. The interactive display 12 may be configured to display the whiteboard input 28 on the touch surface 22.

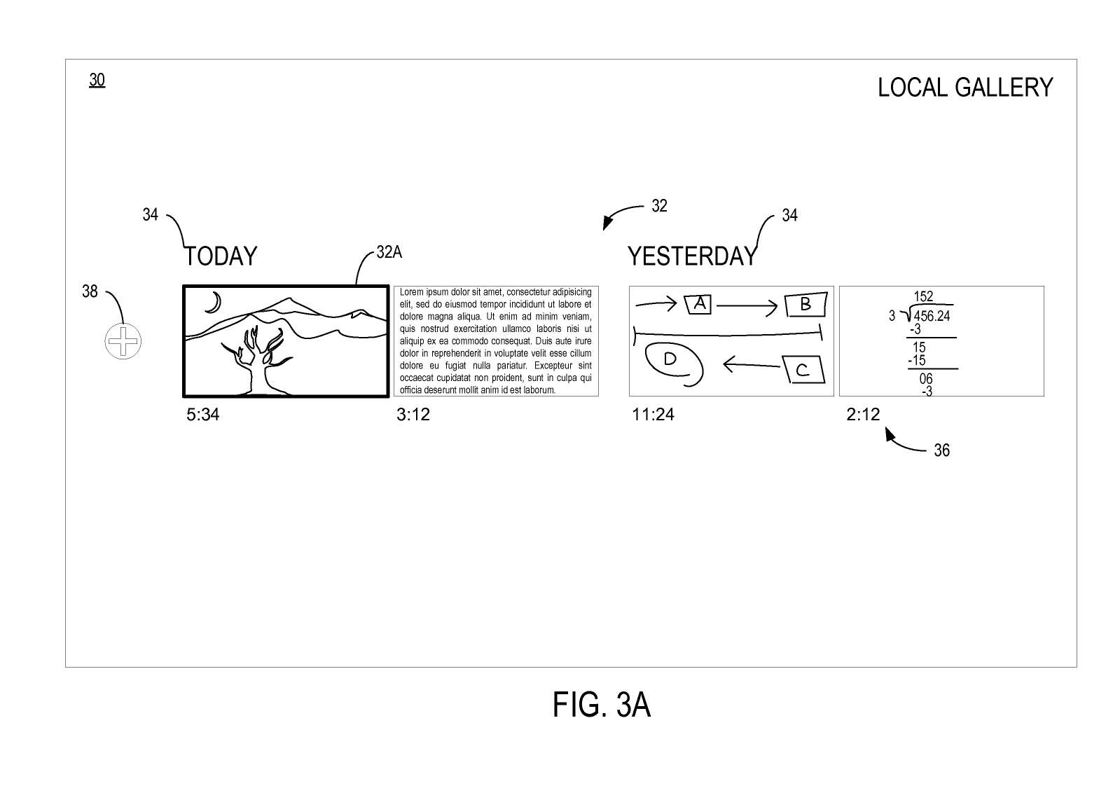

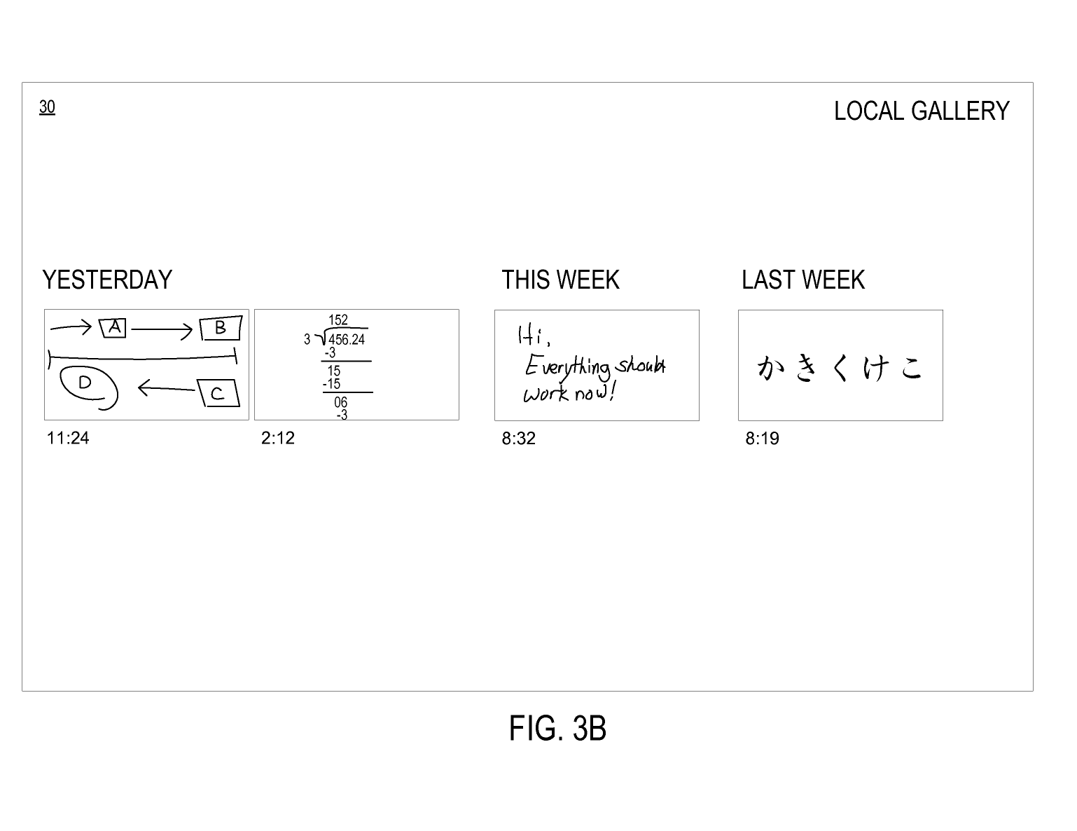

FIG. 3A shows a graphical user interface (GUI) 30 displayed on the interactive display 12 in one arrangement. The GUI 30 is labeled “LOCAL GALLERY” in this example. In this arrangement, each whiteboard file 20 of FIG. 1 is represented by a preview 32 in a single horizontal file. Each preview 32 may be a graphical representation of content of the respective stored whiteboard file 20. The GUI 30 may be used to browse through the whiteboard files 20 stored on the interactive display 12. Alternatively, if the GUI 30 is used to browse whiteboard files 20 stored in a cloud, the label “LOCAL GALLERY” may instead read an associated user account name.

In order to maintain order, save storage space, and/or maintain privacy, any whiteboard file 20 not selected or otherwise retrieved from the memory 18 in a predetermined amount of time may be deleted by the whiteboard application 16. Preview 32A may be selected by a user, prompting the whiteboard application 16 to display the respective whiteboard file 20 on the touch surface 22, as seen in FIG. 1. The preview 32A may be selected via the other device 24 and the respective whiteboard file 20 may be displayed on the touch surface 22 or on a display of the other device 24. In this manner, the other device 24 may be used to browse for a whiteboard file 20 privately before displaying the whiteboard file 20 publicly, for example.

Returning to FIG. 3A, the GUI may include groups 34 such as TODAY, YESTERDAY, THIS WEEK, LAST WEEK, etc. The previews may be sorted into the groups 34 according to a time aspect of the respective whiteboard files 20, for example date created or date last accessed. The time aspect may include metadata 36, which may be associated with each whiteboard file 20 and displayed with each preview 32. In FIG. 3A, each preview in the group 34 is displayed in the GUI 30. The GUI 30 may also include a new file GUI element 38, selectable by touch, cursor, keyboard, etc. Once input has been received selecting the new file GUI element 38, a new whiteboard file may be generated and stored in the memory 18 of the interactive display 12. To navigate the previews, the GUI 30 may be configured to receive a scroll input, for example a touch input 26 in the form of a swipe, a scroll wheel input of a mouse, or a button input. In response, a shifted-over view of the GUI 30 may be generated and displayed on the touch surface 22, as illustrated in FIG. 3B.

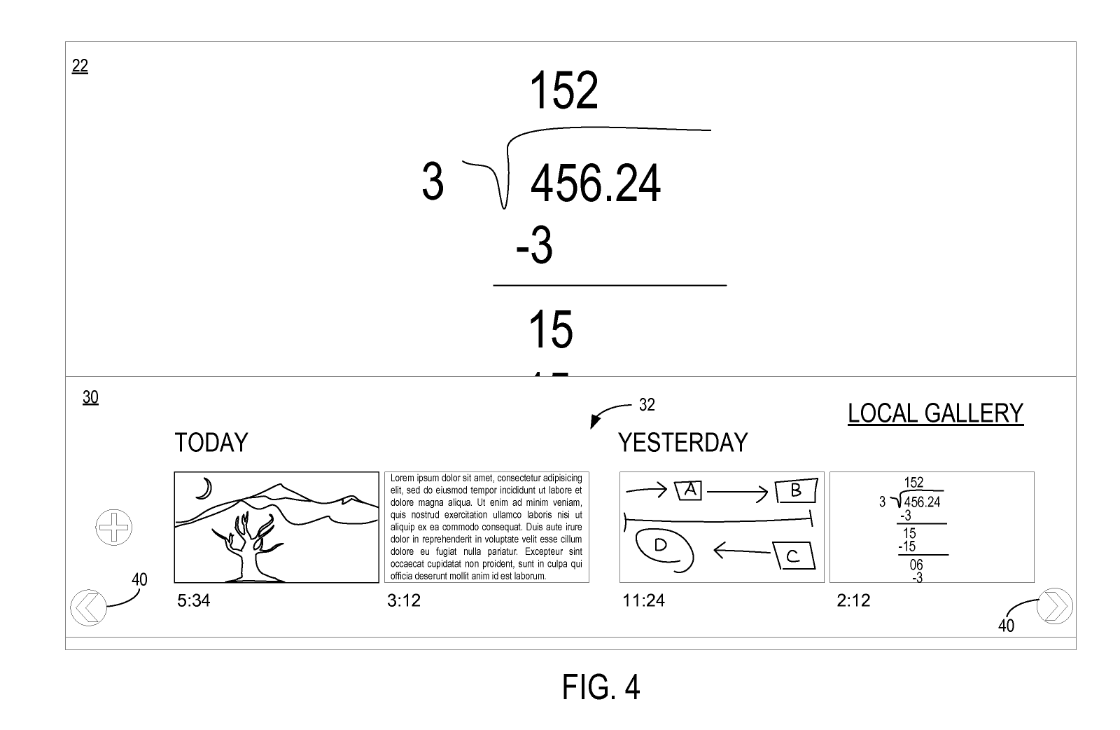

FIG. 4 shows the GUI 30 snapped to a portion of the touch surface 22. In the background, a whiteboard file 20 is displayed. A user may request to navigate the whiteboard files 20 stored in the interactive display 12. In this implementation, the GUI 30 is snapped as a banner at the bottom of the touch surface 22. However, the GUI 30 may be any suitable size and shape. For example, the GUI 30 may also be snapped to the right side of the touch surface 22. FIG. 4 also shows scroll buttons 40 for scrolling left or right through the previews 32. The scroll buttons 40 may skip pages of previews 32 or groups 34, or be held for continuous scrolling, for example.

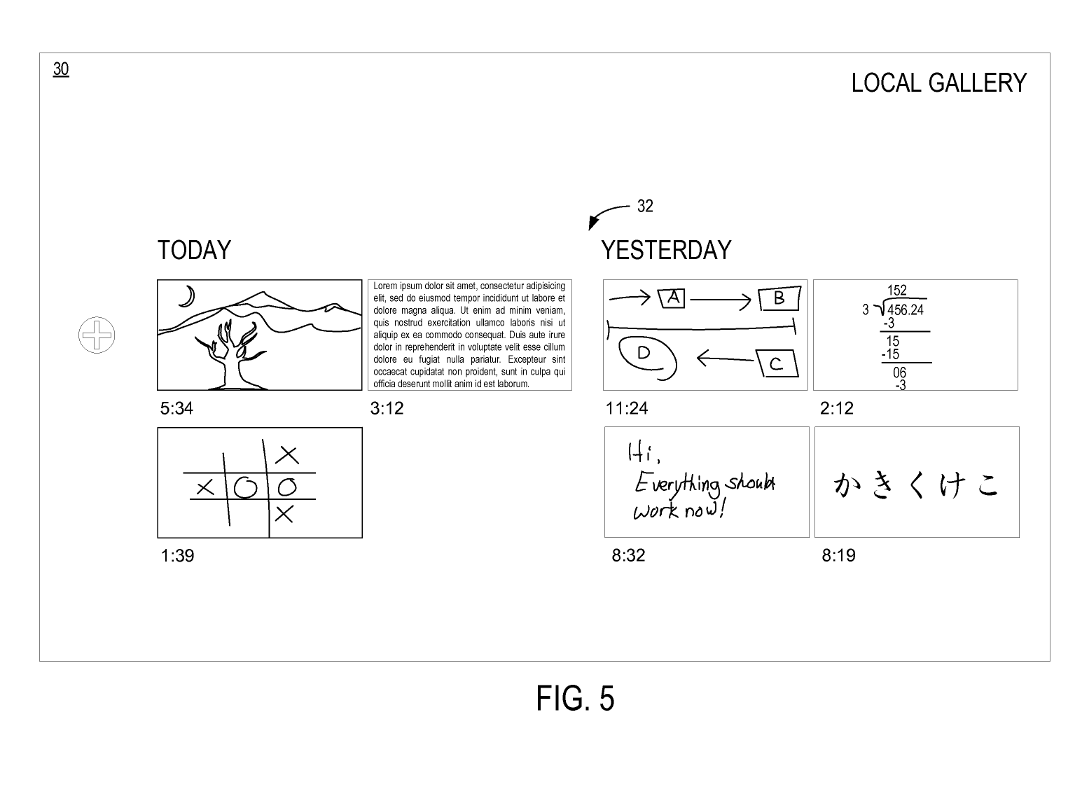

FIG. 5 shows the GUI 30 in another arrangement. The previews 32 may be arranged in multiple rows and/or columns. In this case, the arrangement is depicted as two rows, but more may be acceptable.

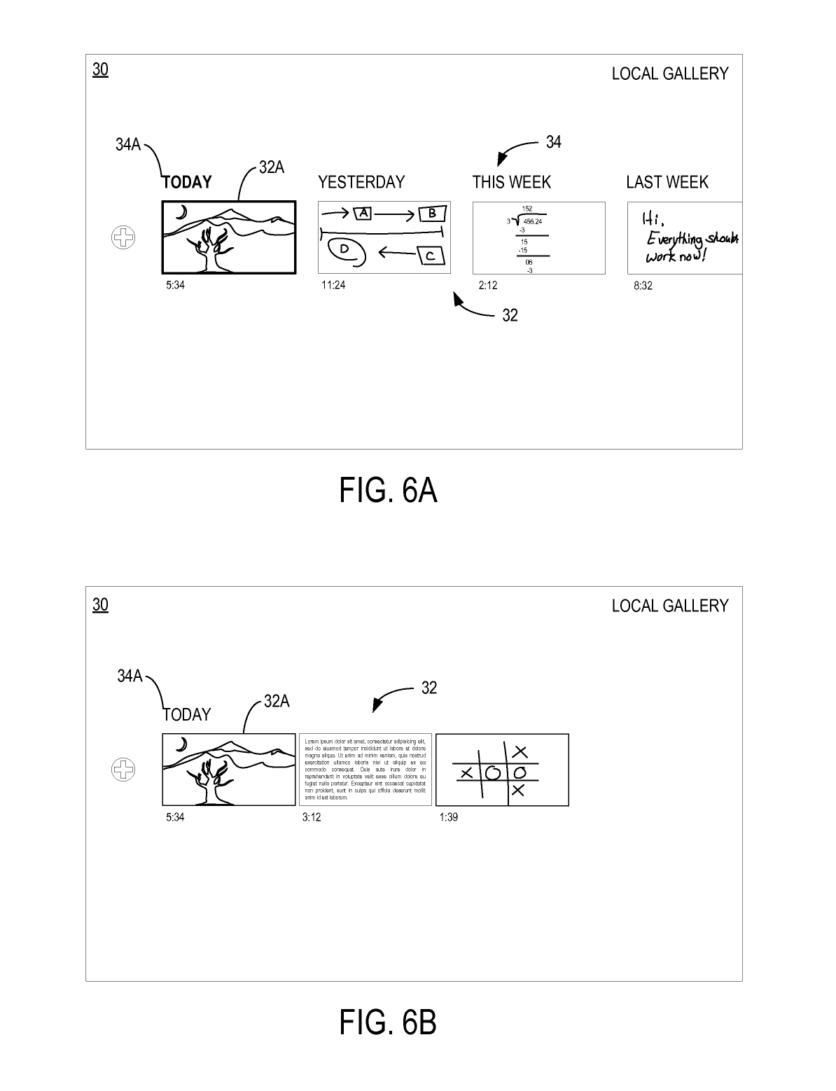

FIGS. 6A and 6B show the GUI 30 in yet another arrangement. In FIG. 6A, the previews 32 are sorted into groups 34 in a first arrangement and only one preview 32 is shown per group 34. Upon receiving a selection input of group 34A, by a user selecting either the group label 34A or the selected preview 32A, the whiteboard application 16 may be configured to display the previews 32 of the selected group 34A in a second arrangement, shown in FIG. 6B. The second arrangement may have any suitable number of columns and rows greater than one.

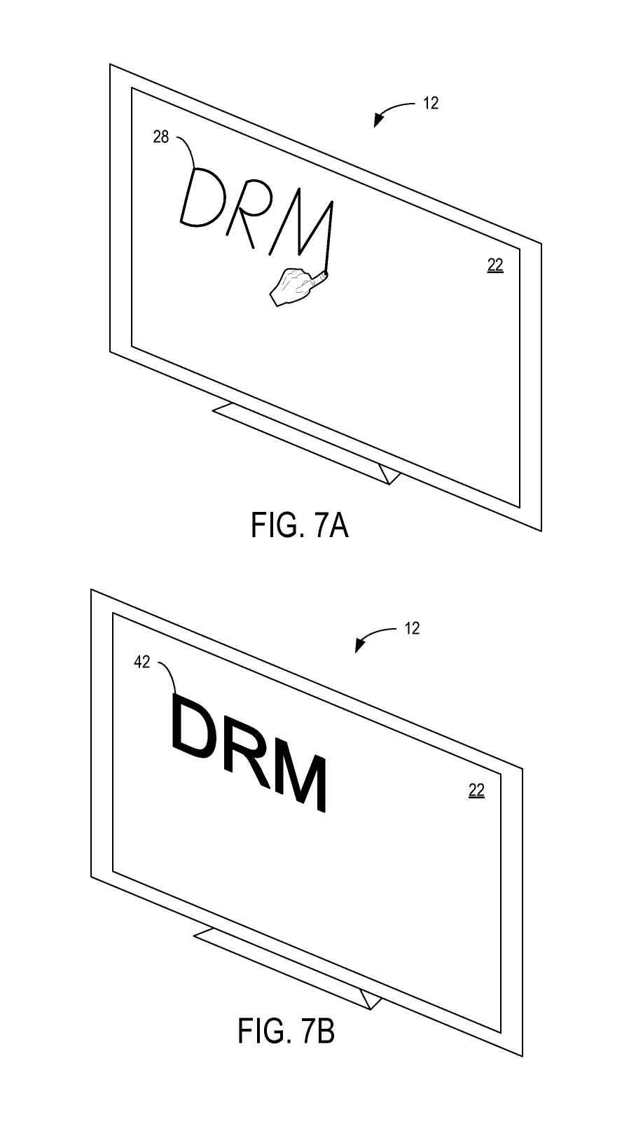

FIGS. 7A and 7B show a confidential mode of the whiteboard application 16. The confidential mode may allow the user increased control over sensitive information. As shown in FIG. 7A, the touch surface 22 may be configured to receive the whiteboard input 28 as a drawing input 28 for an active whiteboard file 20. If the drawing input 28 is determined to be writing, it may be converted into text 42 via handwriting recognition, displayed on the touch surface 22 in FIG. 7B. The text 42 may then be matched to a preset privacy keyword, in this case “DRM,” and a confidential mode may be activated. In the confidential mode, access to the active whiteboard file 20 may be restricted to users with administrative privileges. Alternatively, the active whiteboard file 20 may be prohibited from being stored in the memory 18, prohibited from being transferred to another device, or set to be deleted in a predetermined amount of time.

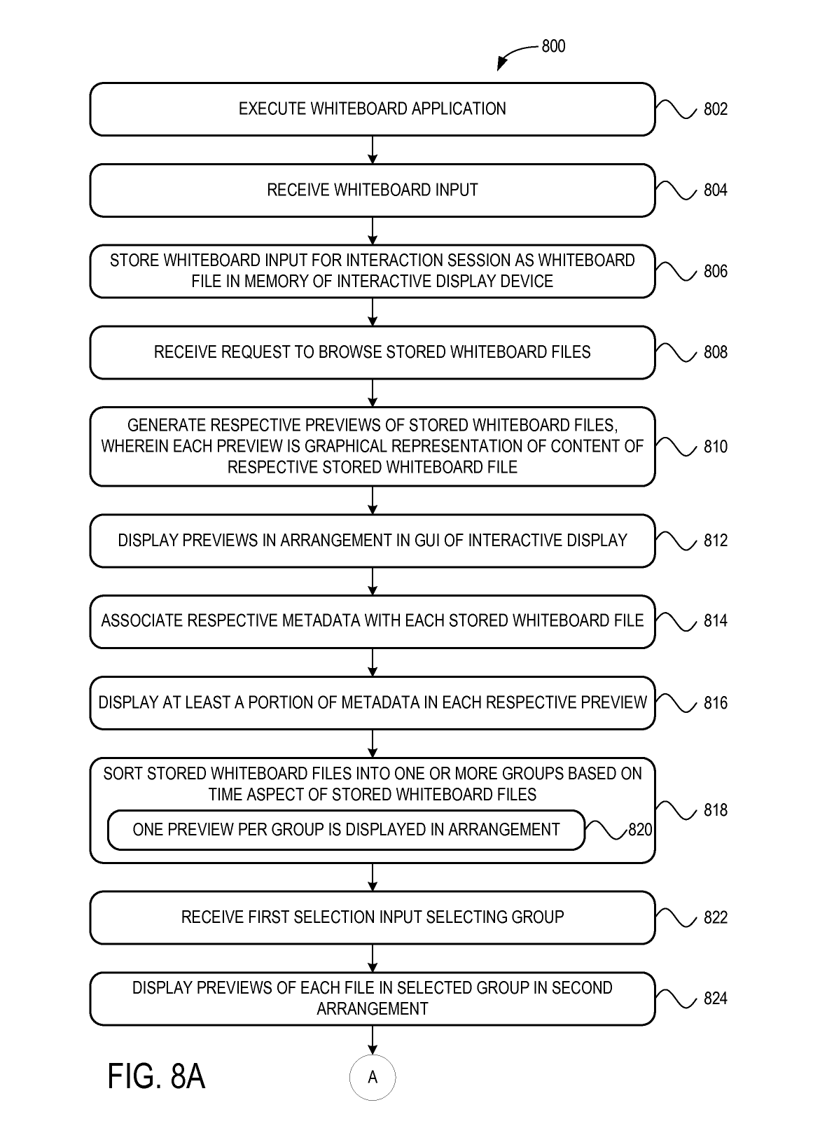

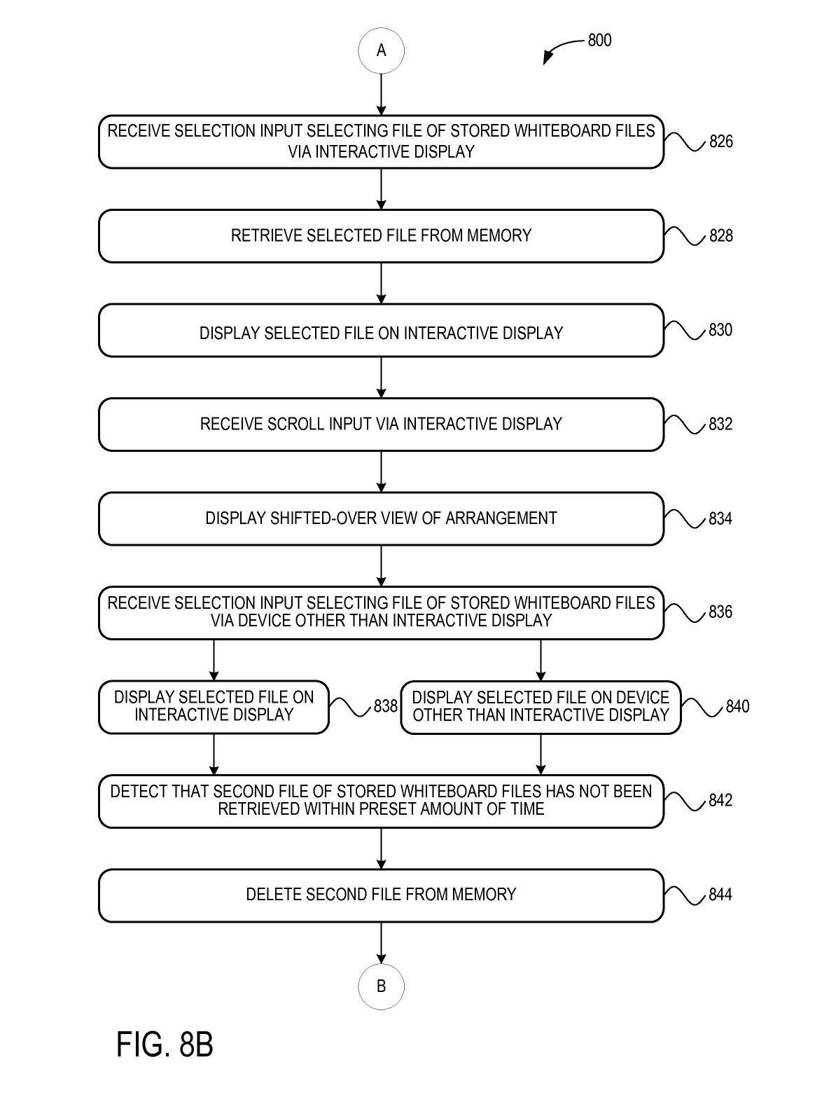

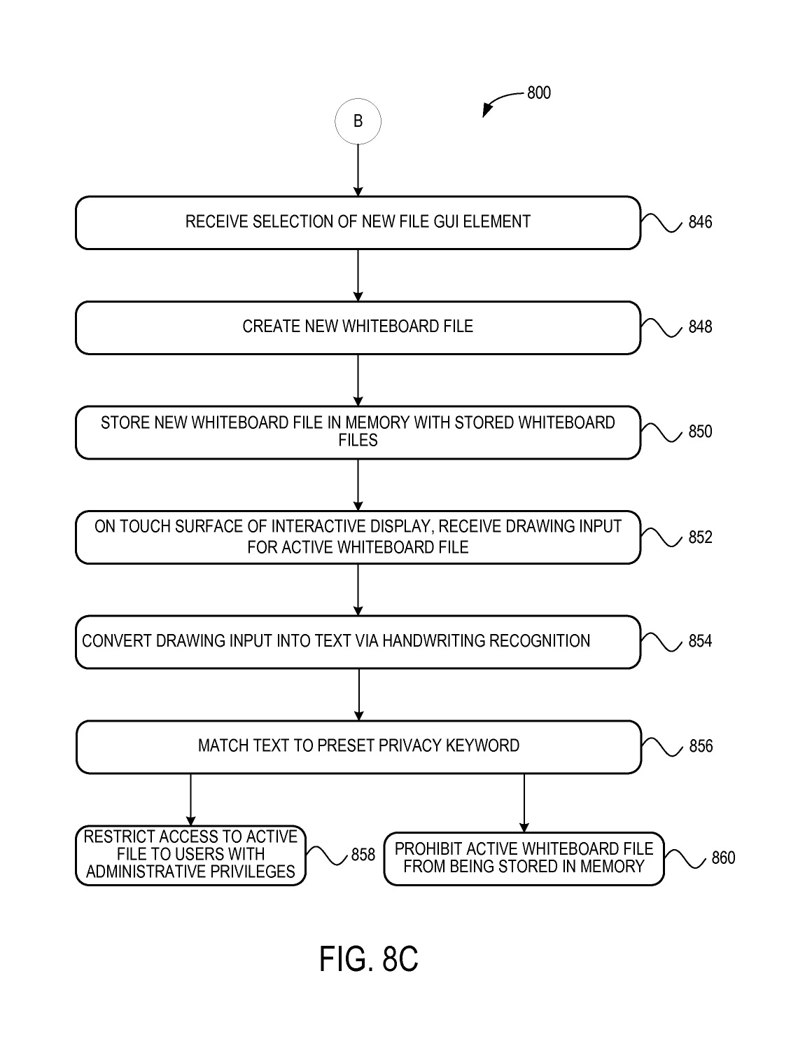

FIGS. 8A-8C illustrate a flowchart of a method 800 of presenting stored files in a whiteboard application executed on an interactive display. The following description of method 800 is provided with reference to the software and hardware components of the interactive display 12 described above and shown in FIGS. 1 and 2. It will be appreciated that method 800 may also be performed in other contexts using other suitable hardware and software components.

With reference to FIG. 8A, at 802 the method 800 may include executing the whiteboard application. For each of a plurality of interaction sessions, at 804 the method 800 may include receiving whiteboard input, and at 806 the method 800 may include storing whiteboard input for an interaction session as a whiteboard file in memory of the interactive display device. In this manner, a plurality of whiteboard files may be stored in the interactive display device. At 808 the method 800 may include receiving a request to browse the stored whiteboard files. At 810 the method 800 may include generating respective previews of the stored whiteboard files, wherein each preview is a graphical representation of content of a respective stored whiteboard file. At 812 the method 800 may include displaying the previews in an arrangement in a graphical user interface (GUI) of the interactive display.

At 814 the method 800 may include associating respective metadata with each stored whiteboard file. At 816 the method 800 may include displaying at least a portion of the metadata in each respective preview. At 818 the method 800 may include sorting the stored whiteboard files into one or more groups based on a time aspect of the stored whiteboard files. At 820 one preview per group may be displayed in the arrangement, wherein the arrangement is a first arrangement. Alternatively, one preview per whiteboard file may be displayed.

At 822 the method 800 may include receiving a first selection input selecting a group of the one or more groups. At 824 the method 800 may include displaying the previews of each file in the selected group in a second arrangement. At 826 the method 800 may include receiving a selection input selecting a file of the stored whiteboard files via the interactive display. At 828 the method 800 may include retrieving the selected file from the memory. At 830 the method 800 may include displaying the selected file on the interactive display.

At 832 the method 800 may include receiving a scroll input via the interactive display. At 834 the method 800 may include displaying a shifted-over view of the arrangement. At 836 the method 800 may include receiving the selection input selecting the file of the stored whiteboard files via a device other than the interactive display. At 838 the method 800 may include displaying the selected file on the interactive display. Alternatively, at 840 the method 800 may include displaying the selected file on the device other than the interactive display.

At 842 the method 800 may include detecting that a second file of the stored whiteboard files has not been retrieved within a preset amount of time. At 844 the method 800 may include deleting the second file from the memory. At 846 the method 800 may include receiving selection of a new file GUI element. At 848 the method 800 may include creating a new whiteboard file. At 850 the method 800 may include storing the new whiteboard file in the memory with the stored whiteboard files.

At 852 the method 800 may include, on a touch surface of the interactive display, receiving a drawing input for an active whiteboard file. At 854 the method 800 may include converting the drawing input into text via handwriting recognition. At 856 the method 800 may include matching the text to a preset privacy keyword. At 858 the method 800 may include restricting access to the active whiteboard file to users with administrative privileges. Alternatively, at 860 the method 800 may include prohibiting the active whiteboard file from being stored in the memory.

The above described systems and methods may be used to present stored files in a whiteboard application executed on an interactive display. The application may include a graphical user interface (GUI) arranged according to a variety of implementations. Features such as automatically deleting old files, a confidential mode, and cross-device access may lend the interactive display potential advantages such as versatility and security.

In some embodiments, the methods and processes described herein may be tied to a computing system of one or more computing devices. In particular, such methods and processes may be implemented as a computer-application program or service, an application-programming interface (API), a library, and/or other computer-program product.

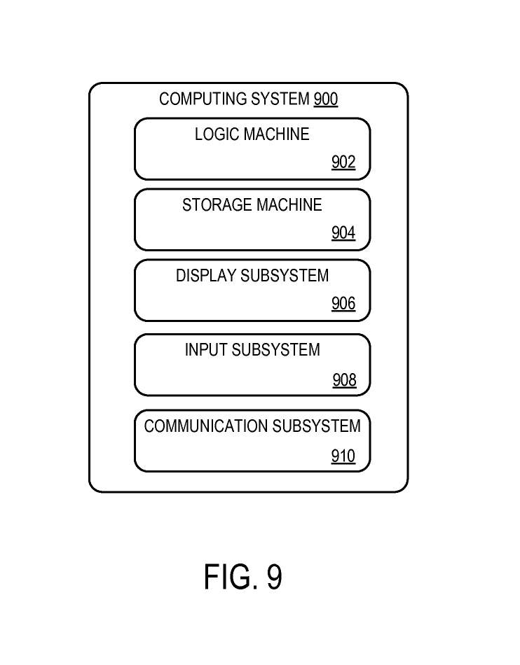

FIG. 9 schematically shows a non-limiting embodiment of a computing system 900 that can enact one or more of the methods and processes described above. Interactive computing system 10 is one example of computing system 900. Computing system 900 is shown in simplified form. Computing system 900 may take the form of a touchscreen display device, as well as any other suitable computing system, including but not limited to game consoles, one or more personal computers, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may also include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic machine 902 executing instructions held by storage machine 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of presenting stored files in a whiteboard application executed on an interactive display, comprising:
executing the whiteboard application;
for each of a plurality of interaction sessions:
receiving whiteboard input;
storing whiteboard input for an interaction session as a whiteboard file in memory of the interactive display device;
receiving a request to browse the stored whiteboard files;
generating respective previews of the stored whiteboard files, wherein each preview is a graphical representation of content of a respective stored whiteboard file;
displaying the previews in an arrangement in a graphical user interface (GUI) of the interactive display;
receiving a selection input selecting a file of the stored whiteboard files via the interactive display;
retrieving the selected file from the memory;
displaying the selected file on the interactive display;
detecting that a second file of the stored whiteboard files has not been retrieved within a preset amount of time; and
deleting the second file from the memory.

2. The method of claim 1, further comprising sorting the stored whiteboard files into one or more groups based on a time aspect of the stored whiteboard files, wherein one preview per group is displayed in the arrangement.

3. The method of claim 2, wherein the arrangement is a first arrangement, the method further comprising:
receiving a first selection input selecting a group of the one or more groups; and
displaying the previews of each file in the selected group in a second arrangement.

4. The method of claim 1, further comprising:
receiving a scroll input via the interactive display; and
displaying a shifted-over view of the arrangement.

5. The method of claim 1, further comprising:
receiving the selection input selecting the file of the stored whiteboard files via a device other than the interactive display;
retrieving the selected file from the memory; and
displaying the selected file on the device other than the interactive display.

6. The method of claim 1, further comprising:
receiving the selection input selecting the file of the stored whiteboard files via a device other than the interactive display;
retrieving the selected file from the memory; and
displaying the selected file on the interactive display.

7. The method of claim 1, further comprising:
receiving selection of a new file GUI element;
creating a new whiteboard file; and
storing the new whiteboard file in the memory with the stored whiteboard files.

8. The method of claim 1, further comprising:
associating respective metadata with each stored whiteboard file; and
displaying at least a portion of the metadata in each respective preview.

9. The method of claim 1, further comprising:
on a touch surface of the interactive display, receiving a drawing input for an active whiteboard file;
converting the drawing input into text via handwriting recognition;
matching the text to a preset privacy keyword; and
restricting access to the active whiteboard file to users with administrative privileges.

10. The method of claim 1, further comprising:
on a touch surface of the interactive display, receiving a drawing input for an active whiteboard file;
converting the drawing input into text via handwriting recognition;
matching the text to a preset privacy keyword; and
prohibiting the active whiteboard file from being stored in the memory.

11. An interactive computing system comprising an interactive display, the interactive display comprising:
a processor configured to execute a whiteboard application; and
memory configured to store at least one whiteboard file;
wherein the whiteboard application is configured to:
for each of a plurality of interaction sessions:
receive whiteboard input; and
store whiteboard input for an interaction session as a whiteboard file in memory of the interactive display device;
receive a request to browse the stored whiteboard files;
generate respective previews of the stored whiteboard files, wherein each preview is a graphical representation of content of a respective stored whiteboard file;
display the previews in an arrangement in a graphical user interface (GUI) of the interactive display;
receive a selection input selecting a file of the stored whiteboard files via the interactive display;
retrieve the selected file from the memory;
display the selected file on the interactive display;
detect that a second file of the stored whiteboard files has not been retrieved within a preset amount of time; and
delete the second file from the memory.

12. The interactive computing system of claim 11, wherein the whiteboard application is further configured to sort the stored whiteboard files into one or more groups based on a time aspect of the stored whiteboard files, wherein one preview per group is displayed in the arrangement.

13. The interactive computing system of claim 12, wherein the arrangement is a first arrangement, the whiteboard application further configured to:
receive a first selection input selecting a group of the one or more groups; and
display the previews of each file in the selected group in a second arrangement.

14. The interactive computing system of claim 11, wherein the whiteboard application is further configured to:
receive a scroll input via the interactive display; and
display a shifted-over view of the arrangement.

15. The interactive computing system of claim 11, wherein the whiteboard application is further configured to:
receive the selection input selecting the file of the stored whiteboard files via a device other than the interactive display;
retrieve the selected file from the memory; and
display the selected file on the device other than the interactive display.

16. The interactive computing system of claim 11, wherein the whiteboard application is further configured to:
receive the selection input selecting the file of the stored whiteboard files via a device other than the interactive display;
retrieve the selected file from the memory; and
display the selected file on the interactive display.

17. The interactive computing system of claim 11, wherein the whiteboard application is further configured to:
associate respective metadata with each stored whiteboard file; and
display at least a portion of the metadata in each respective preview.

18. The interactive computing system of claim 11, wherein the whiteboard application is further configured to:
via a touch surface of the interactive display, receive a drawing input for an active whiteboard file;
convert the drawing input into text via handwriting recognition;
match the text to a preset privacy keyword; and
restrict access to the active whiteboard file to users with administrative privileges.

19. The interactive computing system of claim 11, wherein the whiteboard application is further configured to:
via a touch surface of the interactive display, receive a drawing input for an active whiteboard file;
convert the drawing input into text via handwriting recognition;
match the text to a preset privacy keyword; and
prohibit the active whiteboard file from being stored in the memory.

20. An interactive computing system comprising an interactive display, the interactive display comprising:
a processor configured to execute a whiteboard application; and
memory configured to store at least one whiteboard file;
wherein the whiteboard application is configured to:
for each of a plurality of interaction sessions:
receive whiteboard input; and
store whiteboard input for an interaction session as a whiteboard file in memory of the interactive display device;
receive a request to browse the stored whiteboard files;
generate respective previews of the stored whiteboard files, wherein each preview is a graphical representation of content of a respective stored whiteboard file;
display the previews in an arrangement in a graphical user interface (GUI) of the interactive display;
receive a selection input selecting a file of the stored whiteboard files via the interactive display;
retrieve the selected file from the memory;
display the selected file on the interactive display;
detect that a second file of the stored whiteboard files has not been retrieved within a preset amount of time;
delete the second file from the memory;
via a touch surface of the interactive display, receive a drawing input for an active whiteboard file;
convert the drawing input into text via handwriting recognition;
match the text to a preset privacy keyword; and
restrict access to the active whiteboard file to users with administrative privileges.
